(19) United States
(12) Patent Application Publication
(10) Pub. No.: US 2010/0200711 A1
(43) Pub. Date: Aug. 12, 2010

(54) ELECTRICAL METER STAND AND METHOD OF MANUFACTURING AN ELECTRICAL METER STAND

(76) Inventor: Eric Schoenfeld, Wainscott, NY (US)

Correspondence Address: MICHAEL BEST & FRIEDRICH LLP, 100 E WISCONSIN AVENUE, Suite 3300, MILWAUKEE, WI, 53202, US

(21) Appl. No.: 12/367,743

(22) Filed: Feb. 9, 2009

(51) Int. Cl. F16M 11/02; B23P 17/00

(52) U.S. Cl. 248/176.1; 29/897.3

(57) ABSTRACT

A meter stand and a method of manufacturing a meter stand. The meter stand includes a first post and a second post substantially parallel to the first post, each of the first post and the second post comprising a PVC hollow structure. The meter stand also includes a first support, a second support, and a third support extending between the first post and the second post. The first support, the second support, and the third support comprise a composite plastic material and are positioned on the first post and the second post to accommodate a meter box.

### BACKGROUND OF THE INVENTION

Electrical meter stands are used to mount electrical meter boxes that contain electrical wiring and electrical components for 200 amp, 320 amp, 400/600 amp, and 600/800 amp service. Meter stands are generally manufactured from wood materials. These wooden meter stands are satisfactory but have a limited life span and are not an attractive structure. The existing wooden structure has several disadvantages. The structure is exposed to insects such as termites that eventually destroy the structure. In order to alleviate this problem, the wood in the meter stand is pressure-treated and treated with chemicals to protect the wood from being destroyed by insects. In addition, when installing the wooden structure into the ground it must be coated with creosote to protect the structure from corrosion due to water intrusion. Further, the wooden structure is exposed to the atmosphere and weather conditions and must be stained and sealed to preserve the structure from deteriorating. In essence, continuous maintenance is required for the existing wooden structure in order to extend the life of the structure. These maintenance procedures are very costly and time-consuming as well as potentially dangerous when applying chemicals for preservation of the structure. The structure is held together with galvanized hardware and standard nails that eventually rust.

### SUMMARY OF THE INVENTION

Presently, electricians build their own version of a meter stand for mounting electrical meter cabinets. Each one must go through an inspection by the local building department's electrical inspector. There are many different types and versions of meter stands and many fail inspection until properly built to code.

The present invention provides a universal meter stand structure to the marketplace that can save time and money for municipalities and electricians. This new and innovative meter stand also provides consistency of installation and fixed costs to the industry and municipalities.

In one embodiment, the invention provides a meter stand comprising a first post comprising a PVC material, the first post including a front wall, a rear wall, a first side wall, and a second side wall defining an interior of the first post and a second post comprising a PVC material and being oriented substantially parallel to the first post, the second post including a front wall, a rear wall, a first side wall, and a second side wall defining an interior of the second post. The meter stand also comprises a first support comprising a composite plastic material, the first support connected to and extending between the first post and the second post, the first support positioned a first predetermined distance from an upper end of the first post and the second post and a second support comprising a composite plastic material, the second support connected to and extending between the first post and the second post, the second support positioned a second predetermined distance from the upper end of the first post and the second post, the first predetermined distance and the second predetermined distance selected such that the first support and the second support are arranged to receive a meter box of a specific size.

In another embodiment the invention provides a method of manufacturing a meter stand. The method comprises the acts of providing a first hollow post comprising a PVC material and a second hollow post comprising a PVC material. The method also includes connecting a first support between the first post and the second post, the first support comprising a composite plastic material and connecting a second support between the first post and the second post, the second support comprising a composite plastic material, the second support positioned a vertical distance from the first support, the vertical distance being selected such that the first support and the second support are arranged to receive a meter box of a specific size.

Other aspects of the invention will become apparent by consideration of the detailed description and accompanying drawings.

### BRIEF DESCRIPTION OF THE DRAWINGS

FIG. 1 is a front view of a meter stand according to one embodiment of the present invention.

FIG. 2 is a side view of the meter stand illustrated in FIG. 1.

FIG. 3 is a detailed frontal view of the meter stand illustrated in FIG. 1.

FIG. 4 is a partial section view of the meter stand according to line 4-4 in FIG. 3.

FIG. 5 is a section view of the meter stand according to line 5-5 in FIG. 3.

FIG. 6A is a front view of a first support of the meter stand illustrated in FIG. 1.

FIG. 6B is a section view of the first support illustrated in FIG. 6A.

FIG. 6C is a front view of a second support of the meter stand illustrated in FIG. 1.

FIG. 6D is a section view of the second support illustrated in FIG. 6C.

FIG. 7A is a detailed view of a post and cap assembly of the meter stand illustrated in FIG. 1.

FIG. 7B is a top view of a cap illustrated in FIG. 7A.

FIG. 8 is an elevation view of the meter stand illustrated in FIG. 1 supporting a meter.

FIG. 9 is a side view of the meter stand illustrated in FIG. 1 supporting a meter.

FIG. 10 is a front view of a meter stand according to one embodiment of the present invention.

FIG. 11 is a side view of the meter stand illustrated in FIG. 10.

FIG. 12 is a detailed frontal view of the meter stand illustrated in FIG. 10.

FIG. 13 is a partial section view of the meter stand according to line 4-4 in FIG. 12.

FIG. 14 is a section view of the meter stand according to line 5-5 in FIG. 12.

FIG. 15A is a front view of a first support of the meter stand illustrated in FIG. 10.

FIG. 15B is a section view of the first support illustrated in FIG. 15A.

FIG. 15C is a front view of a second support of the meter stand illustrated in FIG. 10.

FIG. 15D is a section view of the second support illustrated in FIG. 15C.

FIG. 16A is a detailed view of a post and cap assembly of the meter stand illustrated in FIG. 10.

FIG. 16B is a top view of a cap illustrated in FIG. 16A.

FIG. 17 is an elevation view of meter stand illustrated in FIG. 10 supporting a meter.

FIG. 18 is a side view of the meter stand illustrated in FIG. 10 supporting the meter.

FIG. 19 is a front view of a meter stand according to one embodiment of the present invention.

FIG. 20 is a side view of the meter stand illustrated in FIG. 19.

FIG. 21 is a detailed frontal view of the meter stand illustrated in FIG. 19.

FIG. 22 is a partial section view of the meter stand according to line 4-4 in FIG. 21.

FIG. 23 is a section view of the meter stand according to line 5-5 in FIG. 21.

FIG. 24A is a front view of a first support of the meter stand illustrated in FIG. 19.

FIG. 24B is a section view of the first support illustrated in FIG. 24A.

FIG. 24C is a front view of a second support of the meter stand illustrated in FIG. 19.

FIG. 24D is a section view of the second support illustrated in FIG. 24C.

FIG. 25A is a detailed view of a post and cap assembly of the meter stand illustrated in FIG. 19.

FIG. 25B is a top view of a cap illustrated in FIG. 25A.

FIG. 26 is an elevation view of the meter stand illustrated in FIG. 19 supporting a meter.

FIG. 27 is a side view of the meter stand illustrated in FIG. 19 supporting a meter.

FIG. 28 is a front view of a meter stand according to one embodiment of the present invention.

FIG. 29 is a side view of the meter stand illustrated in FIG. 28.

FIG. 30 is a detailed frontal view of the meter stand illustrated in FIG. 28.

FIG. 31 is a partial section view of the meter stand according to line 4-4 in FIG. 30.

FIG. 32 is a section view of the meter stand according to line 5-5 in FIG. 30.

FIG. 33A is a front view of a first support of the meter stand illustrated in FIG. 28.

FIG. 33B is a section view of the first support illustrated in FIG. 33A.

FIG. 33C is a front view of a second support of the meter stand illustrated in FIG. 28.

FIG. 33D is a section view of the second support illustrated in FIG. 33C.

FIG. 34A is a detailed view of a post and cap assembly of the meter stand illustrated in FIG. 28.

FIG. 34B is a top view of a cap illustrated in FIG. 34A.

FIG. 35 is an elevation view of meter stand illustrated in FIG. 28 supporting a meter.

FIG. 36 is a side view of the meter stand illustrated in FIG. 28 supporting a meter.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

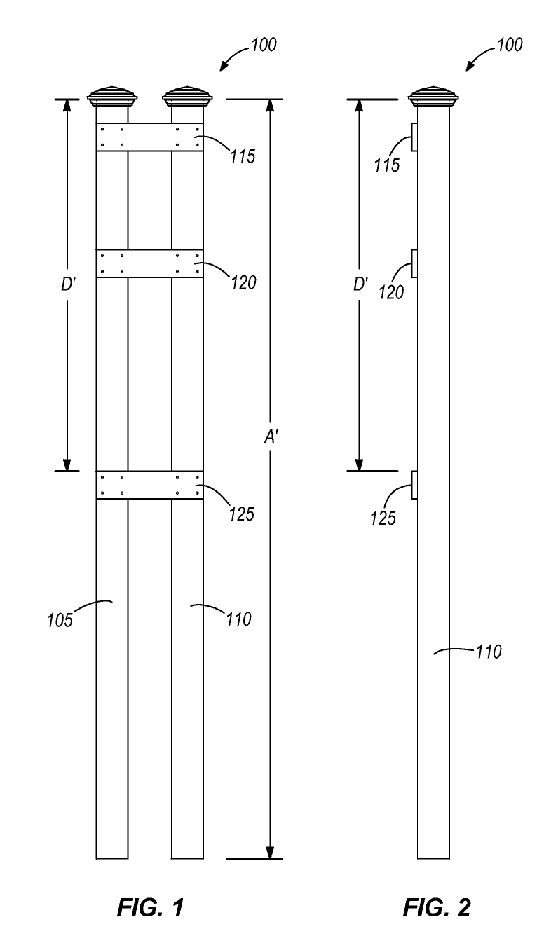

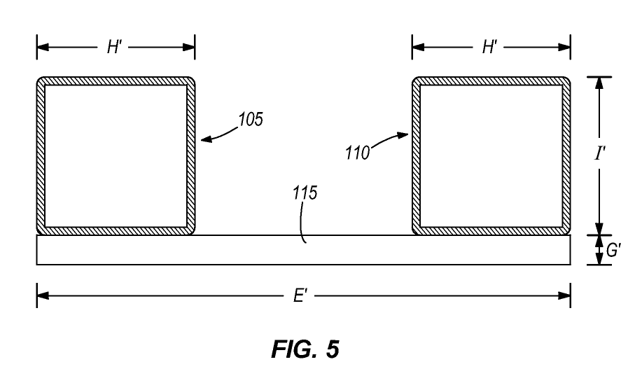

FIGS. 1-9 illustrate a meter stand 100 according to an embodiment of the present invention. The meter stand 100 includes a first hollow post 105 and a second hollow post 110 spaced a predetermined distance from the first post 105. The first post 105 and the second post 110 are oriented substantially parallel to each other. In the illustrated construction, each of the first post 105 and the second post 110 includes a front wall, a rear wall, a first side wall, and a second side wall to define a substantially square cross-section (illustrated in FIG. 5). The first post 105 and the second post 110 are comprised of extruded polyvinyl chloride (PVC) having numerous benefits such as a longer life cycle, being maintenance free, and being water resistant. The first post 105 and the second post 110 each include an upper end and a lower end with the upper and lower ends being open to the interior of the post.

The meter stand 100 also includes a first support 115, a second support 120, and a third support 125 with each being connected to the first post 105 and the second post 110. The first support 115, the second support 120, and the third support 125 each include a first end connected to one of the first post 105 and the second post 110 and a second end connected to the other of the first post 105 and the second post 110. The first support 115, the second support 120, and the third support 125 each include a longitudinal axis oriented substantially perpendicular to a longitudinal axis of the first and second posts 105, 110. The supports 115, 120, 125 are vertically spaced from each other to accommodate a particular sized meter box (further discussed below). In addition, the supports 115, 120, 125 comprise a composite plastic material that does not crack, rot, or splinter, and, similar to the PVC material of the posts 105 and 110, provides improved structural support and wear resistance in comparison to wooden posts and supports of conventional meter stands. Other configurations such as a different shaped cross-section of the supports 115, 120, 125 and the posts 105, 110 also are contemplated and fall within the scope of the present invention.

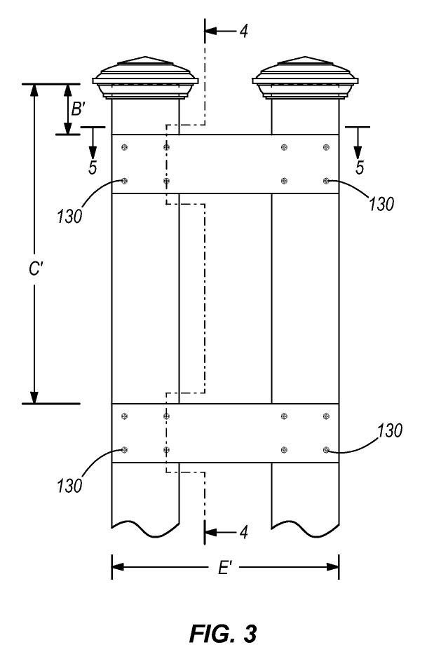

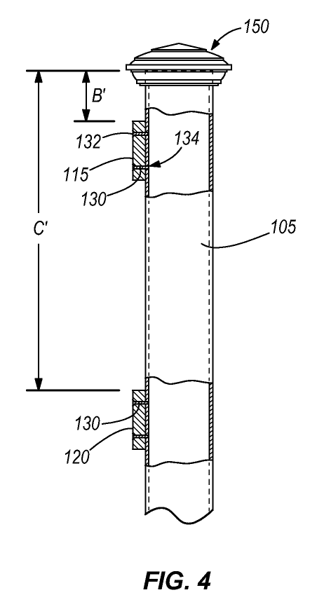

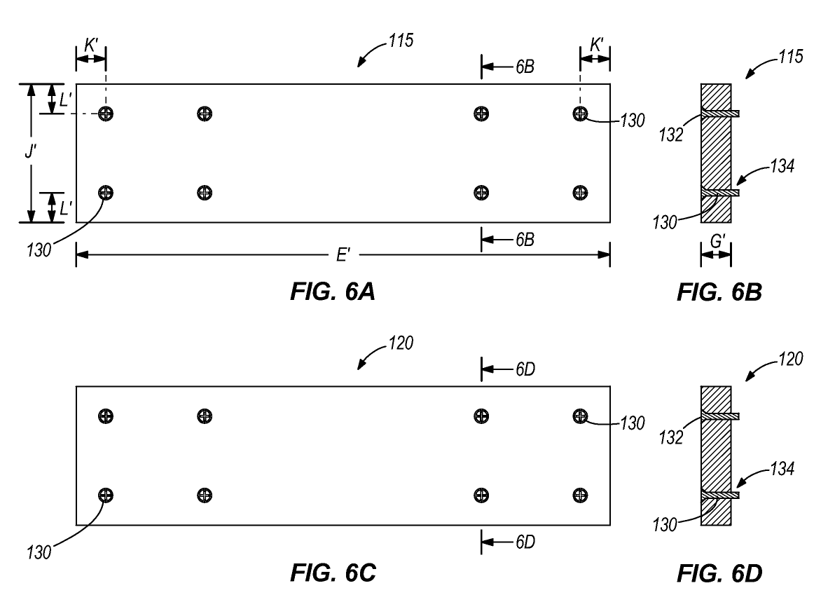

As illustrated in FIGS. 3-4, the first support 115 is positioned a predetermined distance (further specified below) from the upper end of the first and second posts 105, 110. The first end of the first support 115 is substantially flush with the first side wall of the first post 105, and the second end of the first support 115 is substantially flush with the second side wall of the second post 110. As illustrated in FIGS. 6A-6D, the first support 115 is connected to the first post 105 and the second post 110 with a plurality of fasteners 130.

In the illustrated construction, some of the plurality of fasteners 130 are positioned substantially adjacent an upper edge of the first support 115 and are substantially horizontally aligned with one another. Also, some of the plurality of fasteners 130 are positioned substantially adjacent a lower edge of the first support 115 and are substantially horizontally aligned with one another. Further, each of the fasteners 130 adjacent the upper edge of the first support 115 is substantially vertically aligned with one corresponding fastener 130 adjacent the lower edge of the first support 115. Further yet, two vertically aligned fasteners 130 also are adjacent each of the first end and the second end of the first support 115.

As illustrated in FIG. 4, the fasteners 130 extend through the first support 115 and at least partially though the front wall of the post 105, 110. More specifically, each of the fasteners 130 is configured such that a head portion 132 of the fastener 130 is flush with a front surface of the first support 115 and an end portion 134 of the fastener 130 extends into the interior of the post 105, 110, but does not extend beyond the rear wall of the post 105, 110. In the illustrated construction, the fasteners 130 comprise high grade stainless steel to prevent corrosion. More specifically, the fasteners 130 are screw type mechanisms comprised of military grade stainless steel. However, it is within the scope of the present invention to utilize other suitable fasteners comprised of other suitable materials. Further, fasteners other than screws for connecting the supports 115, 120, 125 to the posts 105, 110 fall within the scope of the invention.

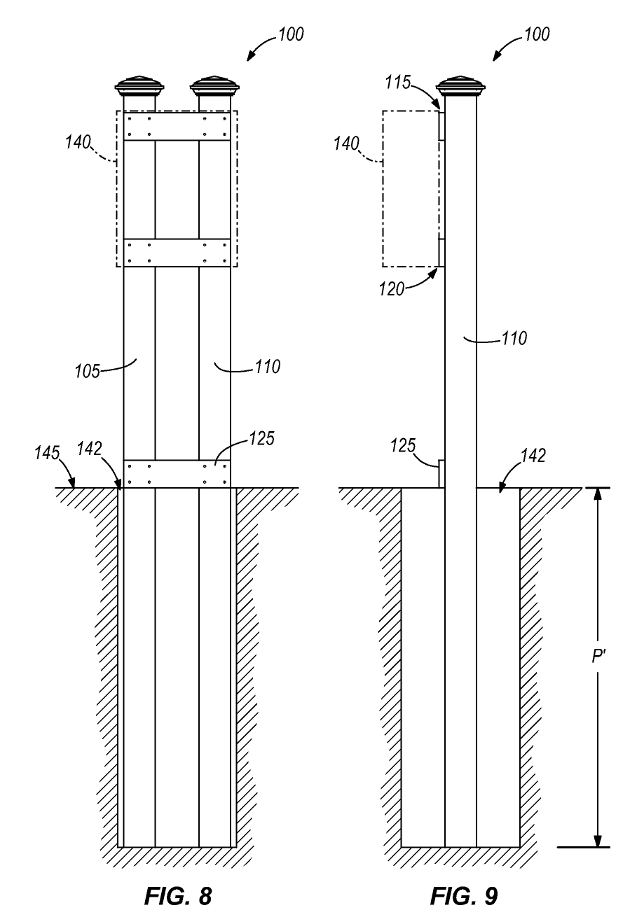

The second support 120 (shown in FIGS. 3, 4, 6C and 6D) and the third support 125 (shown in FIGS. 1 and 2) include similar characteristics and are coupled to the posts 105, 110 in substantially the same fashion as described above with respect to the first support 115. Accordingly, reference is made to the description of the first support 115 for characteristics, limitations and alternatives regarding the second support 120 and the third support 125. With reference to FIGS. 8 and 9, the first support 115 and the second support 120 are configured to support a meter box 140. The meter box 140 is coupled to the first support 115 and the second support 120 of the meter stand 100 via suitable fasteners, such as screws, bolts, nails, and others. The fasteners used for coupling the meter box 140 to the meter stand 100 can include the same or different fasteners 130 used for connecting the supports 115, 120, 125 to the posts 105, 110.

With further reference to FIGS. 8 and 9, the posts 105, 110 of the meter stand 100 are mounted within a hole or aperture 142 below ground level 145 such that the third support 125 is utilized as a guide for indicating the depth at which the meter stand 100 is inserted into the hole 142. In other words, the third support 125 not only provides support to the first and second posts 105, 110 but also is an indicator of the length of the first and second posts 105, 110 which are recessed into the hole 142 for stabilizing the meter stand 100. The third support 125 generally sits flush with the grade and is not recessed or under the grade. The third support 125 is also used as an area to attach a plastic conduit to that runs from inside the meter box to under the ground by a few feet.

In the illustrated construction, the meter stand 100 is provided to an electrician or other installation personnel as an assembled unit. The assembled unit includes the first and second posts 105, 110 and the first, second and third supports 115, 120 and 125 connected to the posts 105, 110 via the fasteners 130. The assembled unit allows the electrician or installation personnel to properly position the meter box without having to make any measurements. The meter box is positioned such that its edges are generally flush with an outside perimeter defined by the first and second posts 105, 110 and the first support 115 and the second support 120 of the meter stand 100. During installation, a wooden post (not shown) is positioned within the interior of each of the posts 105, 110, and then the posts 105, 110 are cemented or otherwise secured into the ground. The wooden posts slide into the interior of the posts 105, 110 without obstruction. As noted above, the end portion 134 of the fasteners 130 extends through the front wall of the post 105, 110 to secure the supports 115, 120, 125 to the post 105, 110, but the end portion 134 of the fasteners 130 do not extend into the interior so as to interfere with the insertion of the wooden post. In alternative constructions, a subterranean anchor or support structure can be incorporated with the meter stand 100 for support within the hole 142.

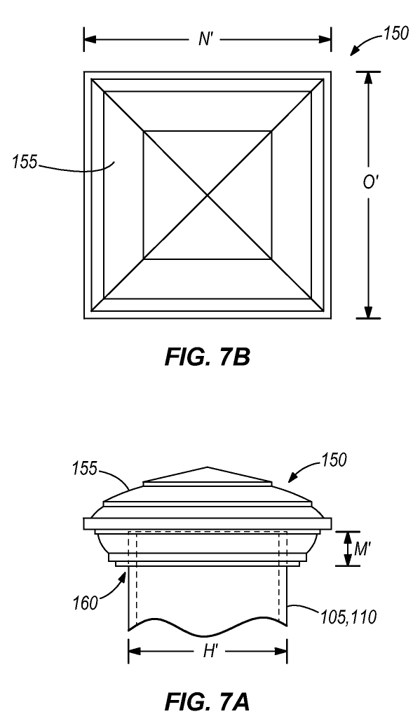

As illustrated in FIGS. 7A and 7B, the meter stand 100 also includes a cap 150, one supported by each of the posts 105, 110, to prevent water or environmental contaminants from entering the interior of the posts 105, 110 and contacting the wooden posts positioned within the posts 105, 110. Each cap 150 includes an outer shell 155 and an aperture 160 for receiving the upper end of the post 105, 110. In the illustrated construction, each of the caps 150 also defines a square-like periphery. Other constructions of the caps 150 also fall within the scope of the present invention. In some constructions, the cap 150 can include coupling mechanisms to snap fit onto the post 105, 110. The cap 150 also can include tabs or surfaces for receiving a bonding agent (e.g., glue, epoxy) for coupling the cap 150 to the post 105, 110. The cap 150 also can include apertures for receiving fastening mechanisms similar to fastening mechanism 130. Other coupling means, forms or mechanisms for coupling the caps 150 to the corresponding post 105, 110 fall within the scope of the invention.

The construction of the meter stand 100 is advantageous over currently available meter stands as the posts 105, 110 constructed of PVC material typically include a life-time warranty. The PVC material of the posts 105, 110 requires little or no maintenance and avoids the use of special chemicals to prevent corrosion. Further, the meter stand 100 including PVC posts 105, 110 provides a more attractive structure than meter stands with wooden posts. In particular, the PVC posts 105, 110 and the composite supports 115, 120, 125 do not need staining or sealing to maintain durability. The posts 105, 110 and the supports 115, 120, 125 do not crack, rot, splinter or allow termite damage in comparison to meter stands including wooden materials. The meter stand 100 also is water resistant and water tight for extended periods of time.

In alternative constructions, the meter stand 100 can be used to mount generator transformers, cabinets, boxes, circuit breaker boxes, switch boxes, timers, road signs, traffic signs, sub-division entrance signs, business display signs, and other like devices.

With reference to FIGS. 1-9, the meter stand 100 is configured to support a meter box (e.g., meter box 140) rated for 200 amps. A meter box has specific dimensions to accommodate the particular power rating. To that end, the first and second posts 105, 110 include a length A′ of about 8 feet, the first support 115 is positioned a distance B′ of about 3 inches from the top of the first and second posts 105, 110, the second support is positioned a distance C′ of about 19 inches from the top of the first and second posts 105, 110, and the third support 125 is positioned a distance D′ of about 47 inches from the top of the first and second posts 105, 110. The meter stand 100 also is positioned a distance P′ of about 46 inches into the hole 142 such that at least a portion of the third support 125 is substantially aligned with ground level 145. During assembly of the meter post 100, wooden posts (not shown) of about 4 inches by 4 inches by 8 feet are placed within the posts 105, 110.

With reference to FIGS. 5-7, the posts 105, 110 define a substantially square cross-section with a width H′ of about 4 inches and a depth I′ of about 4 inches. The first, second, and third supports 115, 120, 125 define a length E′ of about 13.5 inches, a depth G′ of about 0.75 inches, and a height J′ of about 3.5 inches. As indicated above, the outer shell 155 of each of the caps 150 defines a square-like periphery with a width N′ of about 6.25 inches and a width O′ of about 6.25 inches. The caps 150 are mounted onto the posts 105, 110 such that the bottom end of each of the caps 150 is positioned a distance M′ of about 1 inch from the top of the post 105, 110. The horizontally aligned fasteners 130 are positioned a distance L′ of about 0.75 inches from corresponding upper edge and lower edge of the first, second, and third supports 115, 120, 125. The vertically aligned fasteners 130 also are positioned a distance K′ of about 0.75 inches from the first end and the second end of the first, second, and third supports 115, 120, 125.

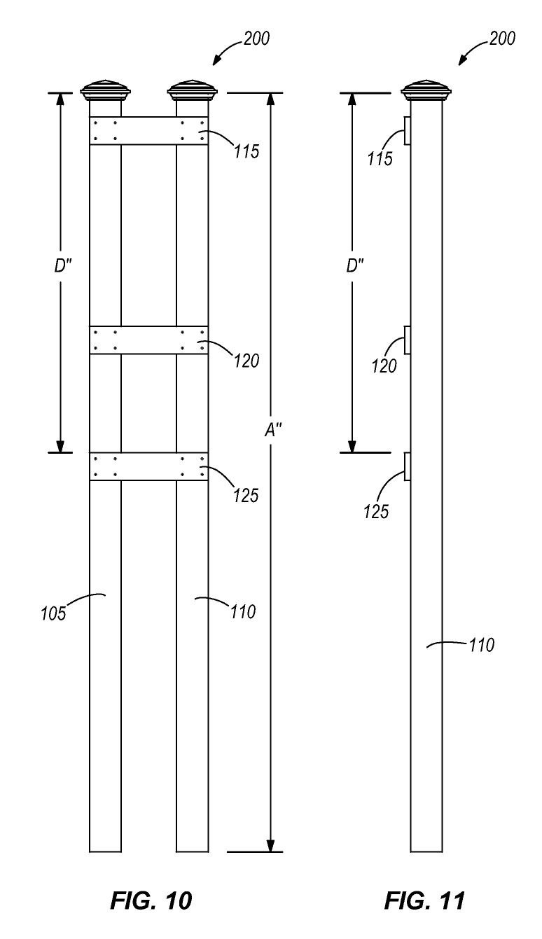

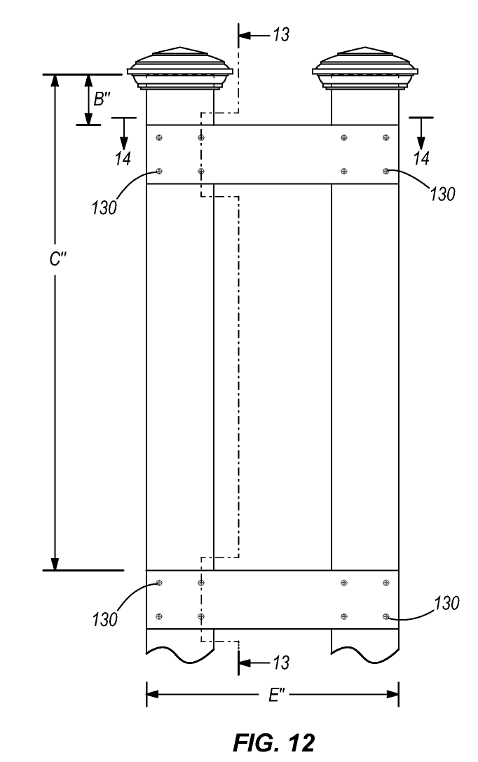

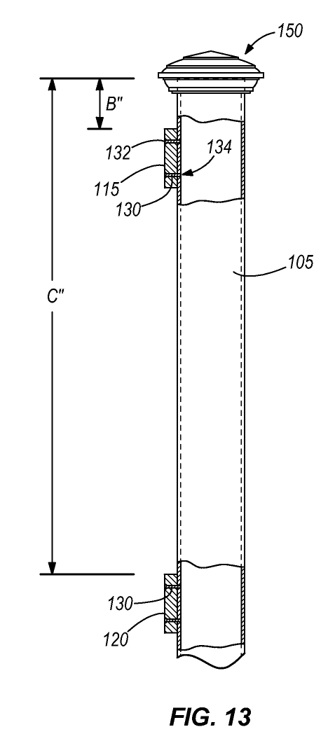

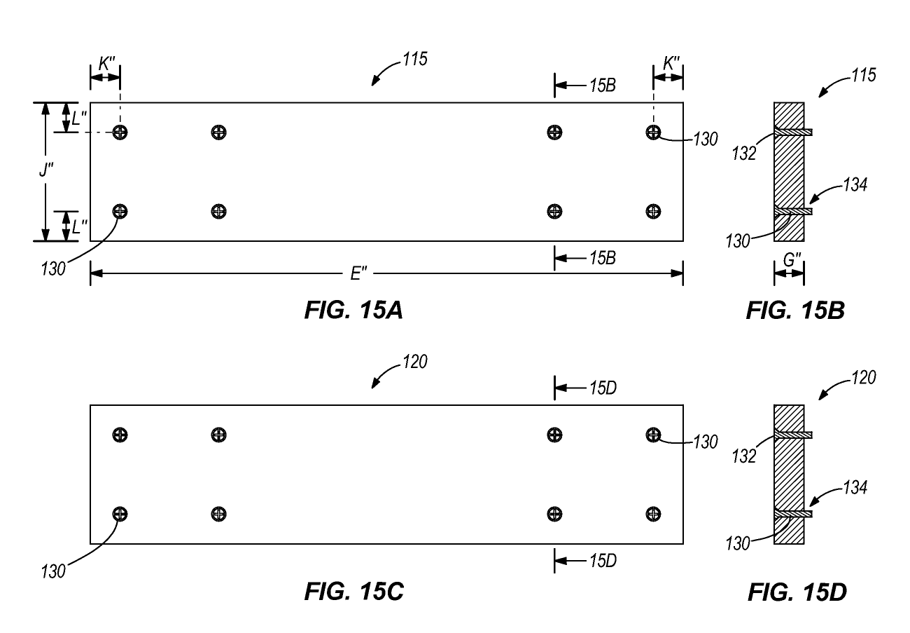

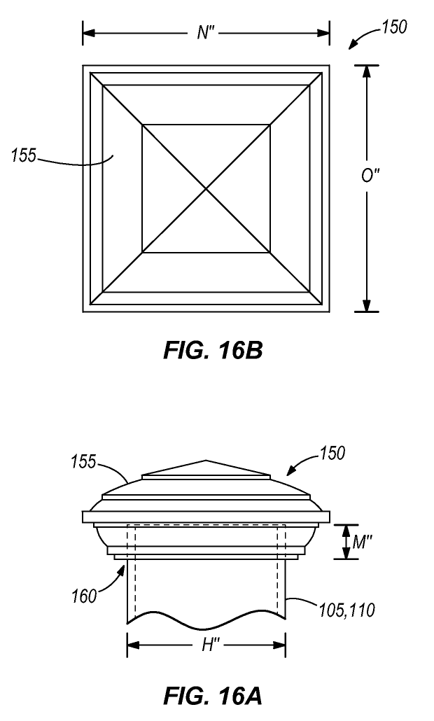

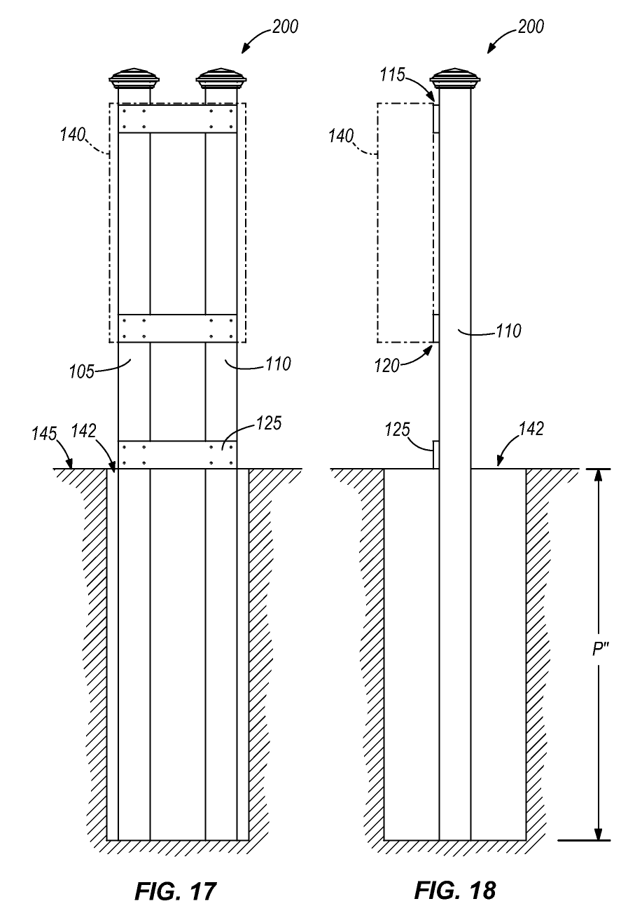

FIGS. 10-18 illustrate a meter stand 200 according to one embodiment of the present invention. The meter stand 200 includes many features in common with other meter stands described in this application and common elements have been given the same reference numerals. Accordingly, reference is made to the other meter stands described in this application for additional features and alternatives to the meter stand 200 and the following description makes reference to the differences between meter stand 200 and other meter stands described in this application.

With reference to FIGS. 10-18, the meter stand 200 is configured to support a meter box (e.g., meter box 140) rated for 320 amps. To that end, the first and second posts 105, 110 include a length A″ of about 8 feet, the first support 115 is positioned a distance B″ of about 3 inches from the top of the first and second posts 105, 110, the second support is positioned a distance C″ of about 29.5 inches from the top of the first and second posts 105, 110, and the third post 125 is positioned a distance D″ of about 45.5 inches from the top of the first and second posts 105, 110. The meter stand 200 also is positioned a distance P″ of about 48 inches into the hole 142 such that at least a portion of the third support 125 is substantially aligned with ground level 145. During assembly of the meter post 200, wooden posts (not shown) of about 4 inches by 4 inches by 8 feet are placed within the posts 105, 110.

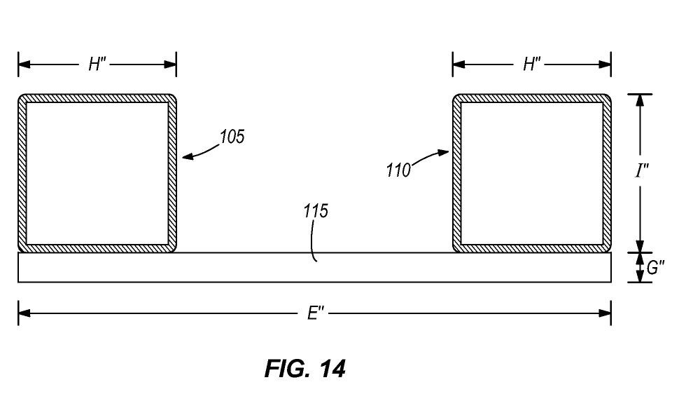

With reference to FIGS. 14-16, the posts 105, 110 define a substantially square cross-section with a width H″ of about 4 inches and a depth I″ of about 4 inches. The first, second, and third supports 115, 120, 125 each define a length E″ of about 15 inches, a depth G″ of about 0.75 inches, and a height J″ of about 3.5 inches. As indicated above, the outer shell 155 of each of the caps 150 defines a square-like periphery with a width N″ of about 6.25 inches and a width O″ of about 6.25 inches. The caps 150 are mounted onto the posts 105, 110 such that the bottom end of each of the caps 150 is positioned a distance M″ of about 1 inch from the top of the post 105, 110. The horizontally aligned fasteners 130 are positioned a distance L″ of about 0.75 inches from corresponding the upper edge and lower edge of the first, second, and third supports 115, 120, 125. The vertically aligned fasteners 130 also are positioned a distance K″ of about 0.75 inches from the first end and the second end of the first, second, and third supports 115, 120, 125.

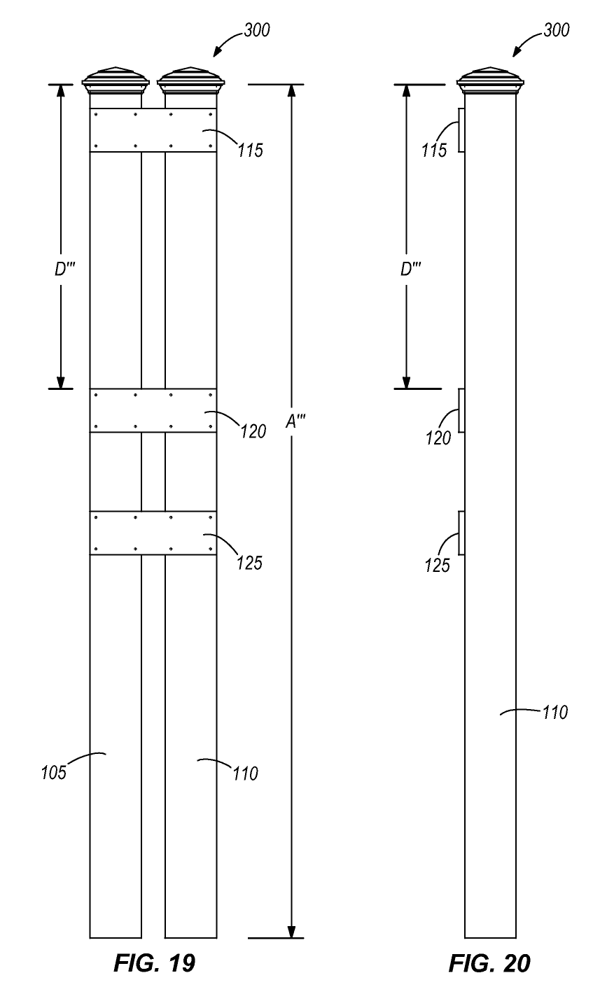

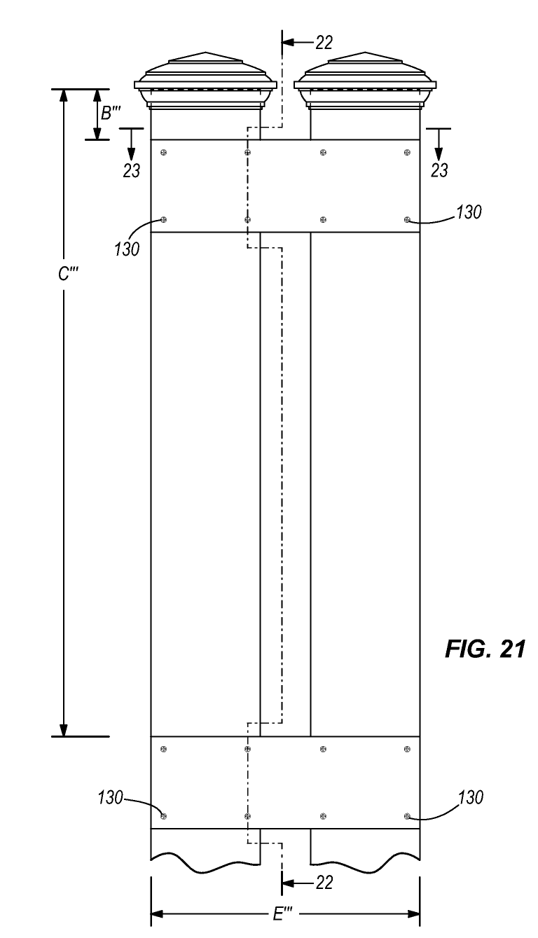

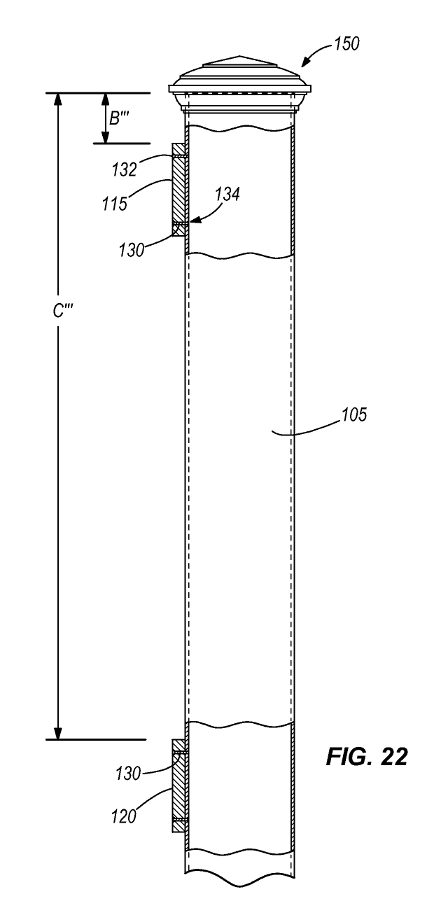

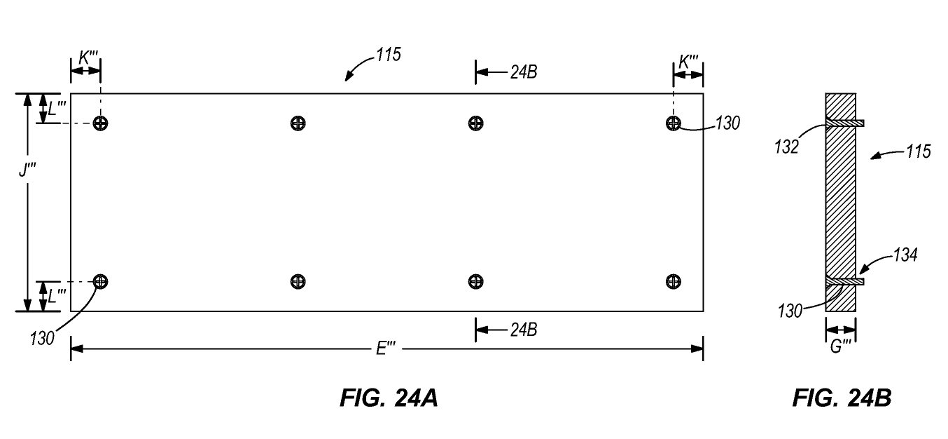

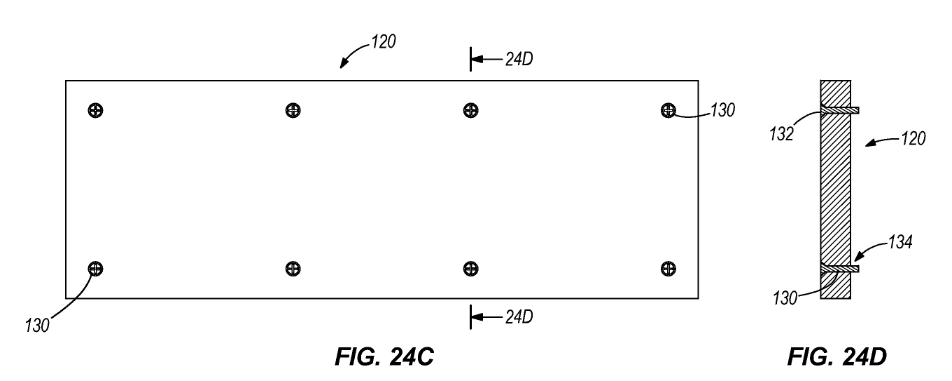

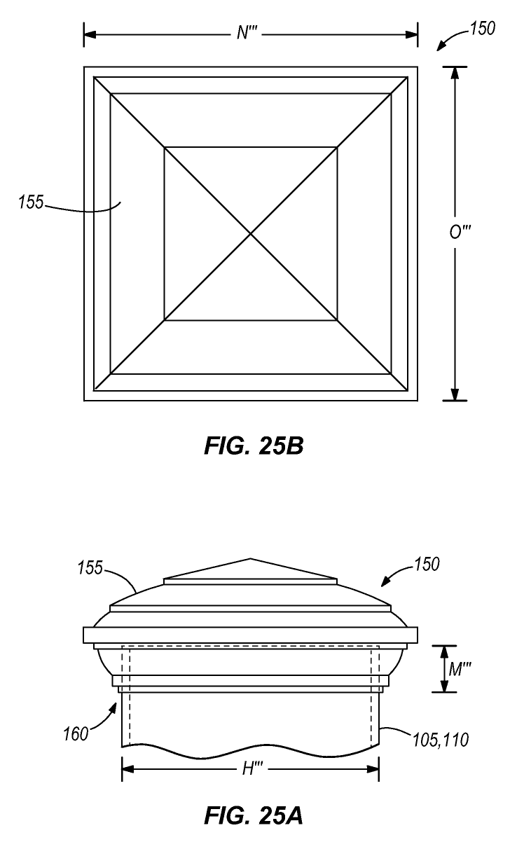

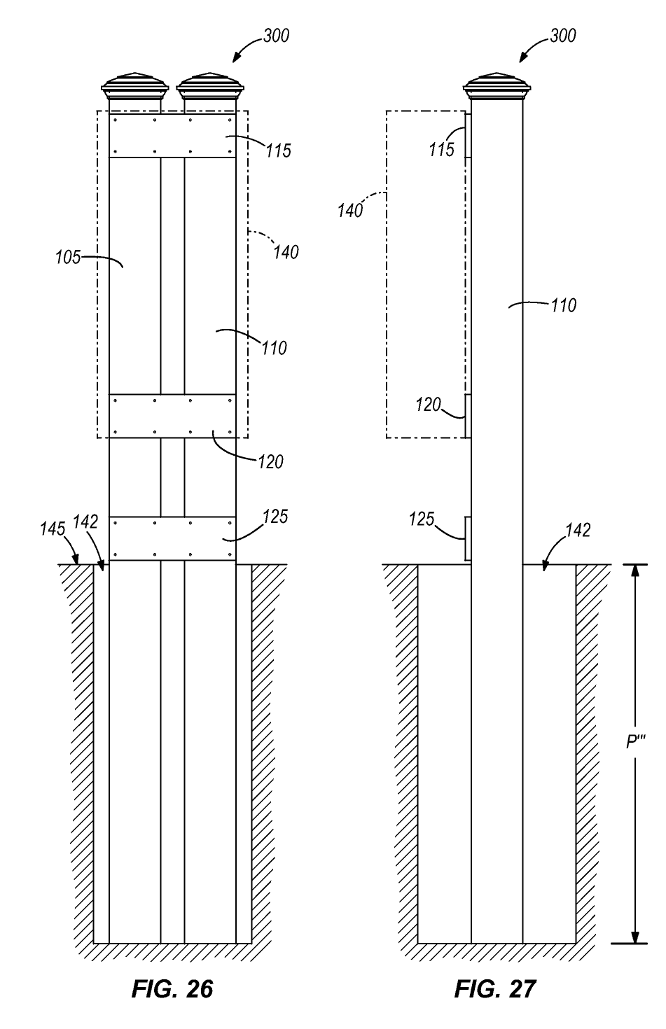

FIGS. 19-27 illustrate a meter stand 300 according to one embodiment of the invention. The meter stand 300 includes many features in common with other meter stands described in this application and common elements have been given the same reference numerals. Accordingly, reference is made to other meter stands described in this application for additional features and alternatives of the meter stand 300 and the following description makes reference to the differences between meter stand 300 and other meter stands described in this application.

With reference to FIGS. 19-27, the meter stand 300 is configured to support a meter box (e.g., meter box 140) rated for 400/600 amps. To that end, the first and second posts 105, 110 include a length A′″ of about 9 feet, the first support 115 is positioned a distance B′″ of about 3 inches from the top of the first and second posts 105, 110, the second support is positioned a distance C′″ of about 38.5 inches from the top of the first and second posts 105, 110, and the third post 125 is positioned a distance D′″ of about 54 inches from the upper end of the first and second posts 105, 110. The meter stand 300 is also positioned a distance P′″ of about 48 inches into the hole 142 such that at least a portion of the third support 125 is substantially aligned with ground level 145. The meter box 140 rated for 400/600 amps include a top wall and a bottom wall that are substantially flush with the first support 115 and the second support 120. The meter box 140 also includes a first side wall and a second side wall that extend about one inch beyond the first post 105 and the second post 110. For example, the meter stand 300 is 16 inches wide, and the meter box 140 is 18 inches wide. The 400/600 amp rated meter box 140 includes a predrilled hole in each corner about four inches from each corner wall. Each predrilled hole receives a fastener 130 to secure the meter box 140 to the first post and the second post 105, 110. This configuration allows the fasteners 130 to be substantially centered with respect to the width of the first post and the second post 105, 110, and to secure to the wooden posts positioned within the first post and the second post 105, 110.

During assembly of the meter post 300, wooden posts (not shown) of about 4 inches by 6 inches by 10 feet or 6 inches by 6 inches by 10 feet are positioned within posts 105, 110.

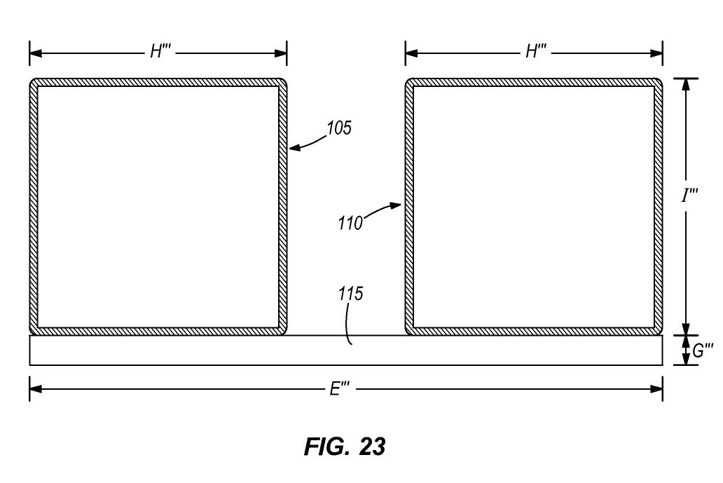

With reference to FIGS. 23-25, the posts 105, 110 define a substantially square cross section with a width H′″ of about 6.5 inches and a depth I′″ of about 6.5 inches. The first, second, and third supports 115, 120, 125 define a length E′″ of about 16 inches, a depth G′″ of about 0.75 inches, and a height J′″ of about 5.5 inches. As indicated above, the outer shell 155 of each of the caps 150 defines a square-like periphery with a width N′″ of about 8.25 inches and a width O′″ of about 8.25 inches. The caps 150 are mounted onto the posts 105, 110 such that the bottom end of each of the caps 150 is positioned a distance M′″ of about 1 inch from the upper end of the post 105, 110. The horizontally aligned fasteners 130 are positioned a distance L′″ of about 0.75 inches from corresponding upper edge and lower edge of the first, second, and third supports 115, 120, 125. The vertically aligned fasteners 130 also are positioned a distance K′″ of about 0.75 inches from the first end and the second end of the first, second and third supports 115, 120, 125.

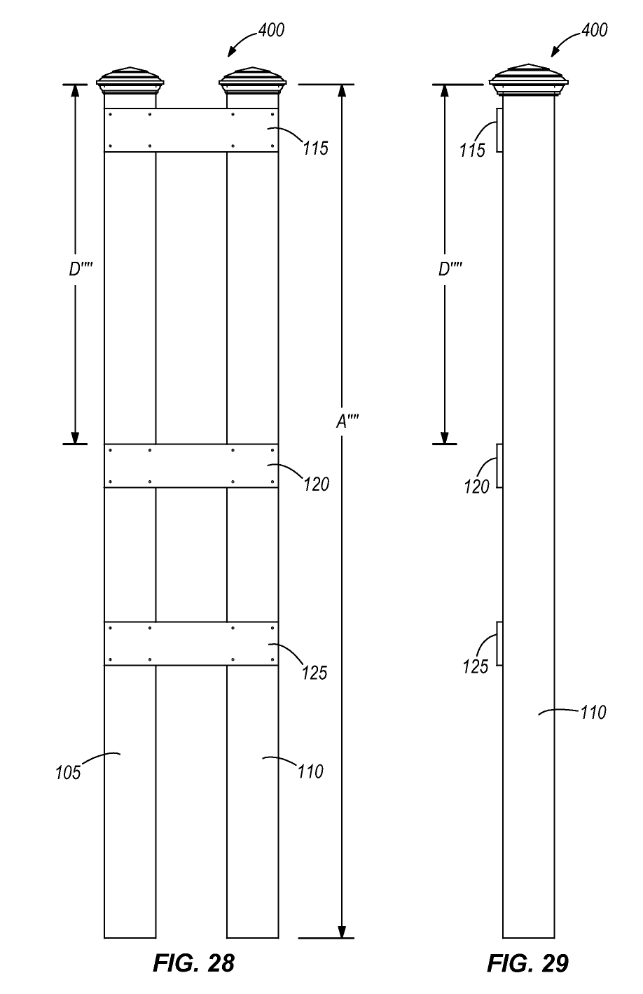

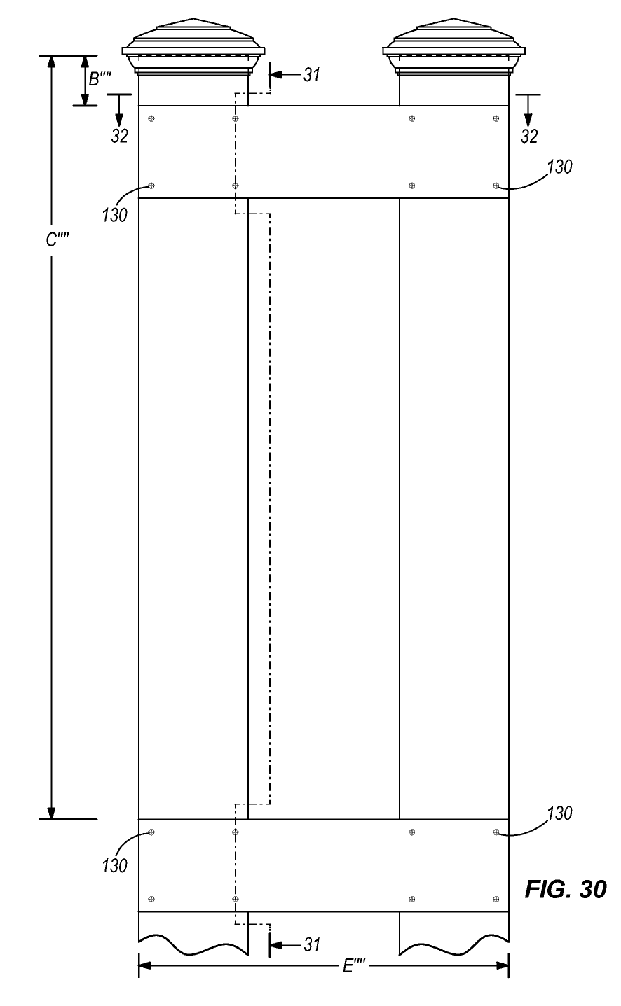

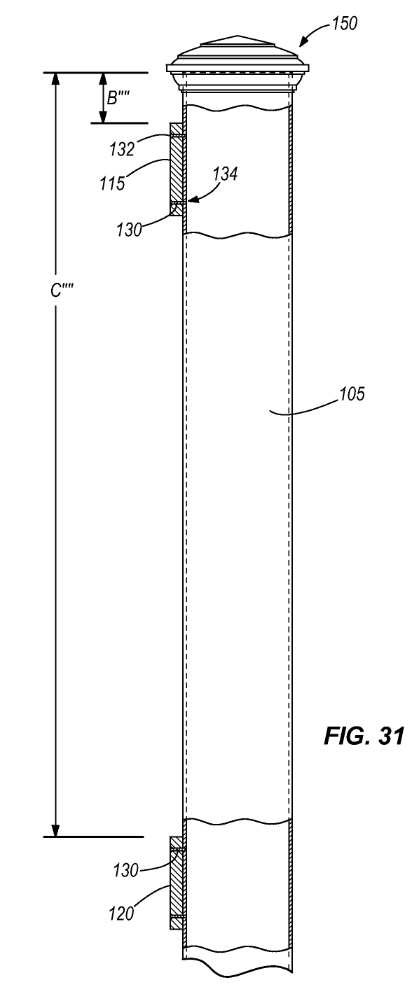

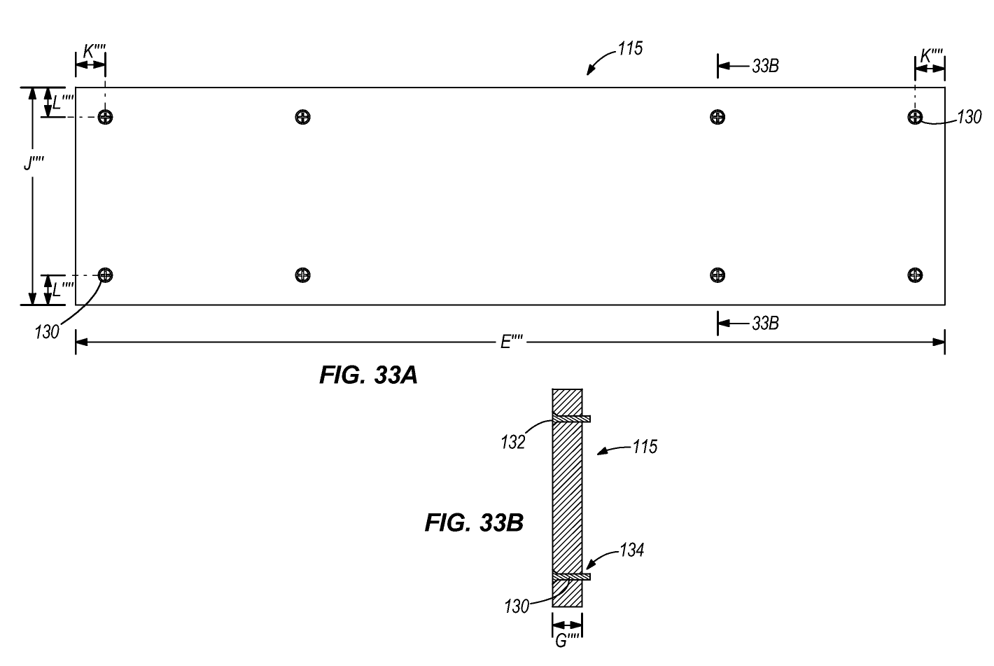

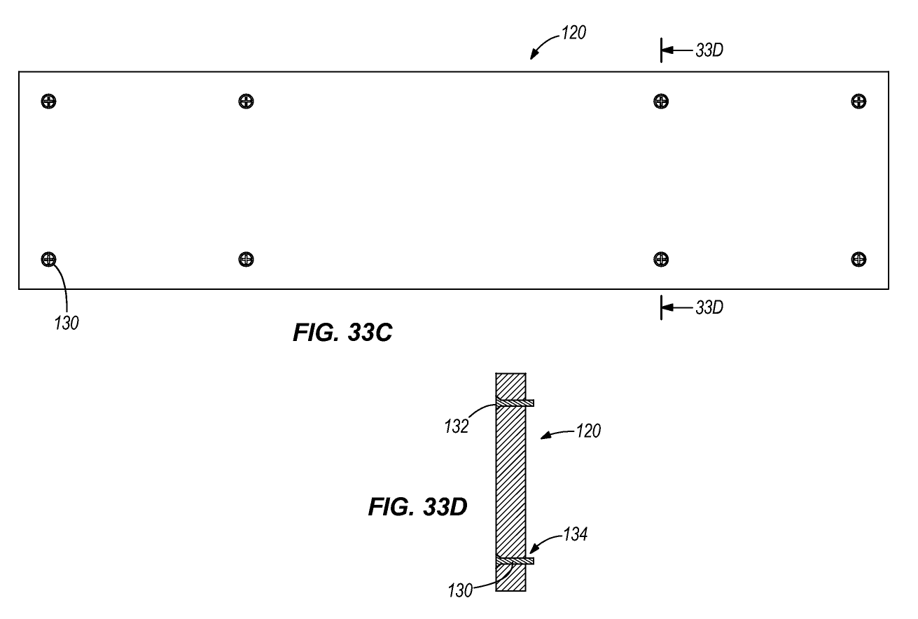

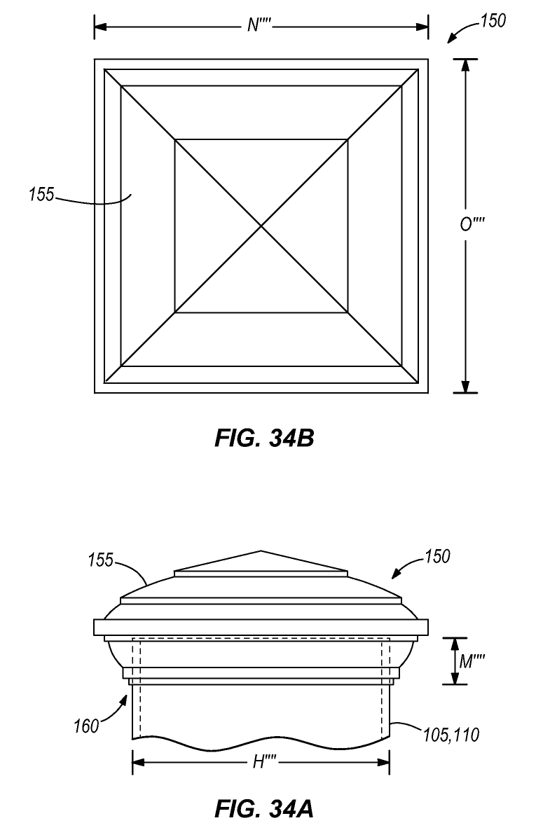

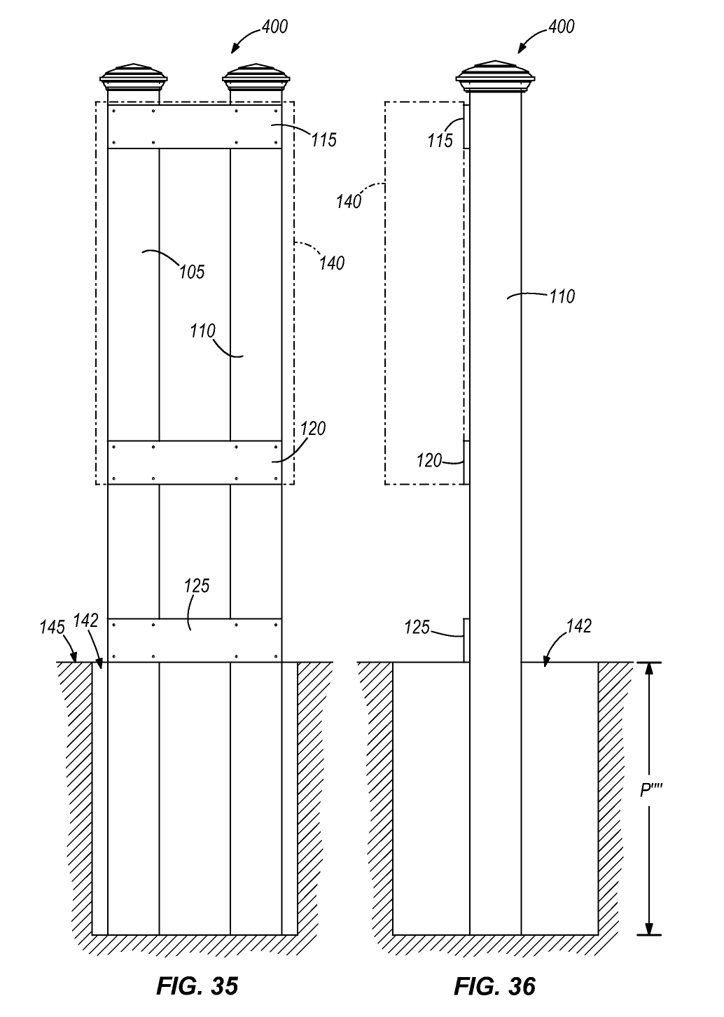

FIGS. 28-36 illustrate a meter stand 400 according to one embodiment of the invention. The meter stand 400 includes many features in common with other meter stands described in this application and common elements have been given the same reference numerals. Accordingly, reference is made to the other meter stands described in this application for additional features and alternatives to the meter stand 400 and the following description makes reference to the differences between meter stand 400 and other meter stands described in this application.

With reference to FIGS. 28-36, the meter stand 400 is configured to support a meter box (e.g., meter box 140) rated for 600/800 amps. To that end, the first and second posts 105, 110 include a length A″″ of about 9 feet, the first support 115 is positioned a distance B″″ of about 3 inches from the upper end of the first and second posts 105, 110, the second support is positioned a distance C″″ of about 45.5 inches from the upper end of the first and second posts 105, 110, and the third support 125 is positioned a distance D″″ of about 68 inches from the upper end of the first and second posts 105, 110. The meter stand 400 also is positioned a distance P″″ of about 48 inches into the hole 142 such that at least a portion of the third support 125 is substantially aligned with the ground level 145. The meter box 140 rated for 600/800 amps includes a top wall and a bottom wall that are substantially flush with the first support 115 and the second support 120. The meter box 140 also includes a first side wall and a second side wall that extend about one inch beyond the first post 105 and the second post 110. For example, the meter stand 400 is about 22 inches wide, and the meter box 140 is about 24 inches wide. The 600/800 amp rated meter box 140 includes a predrilled hole in each corner about four inches from each corner wall. Each predrilled hole receives a fastener 130 to secure the meter box 140 to the first post and the second post 105, 110. This configuration allows the fasteners 130 to be substantially centered with respect to the width of the first post and the second post 105, 110, and to secure to the wooden posts positioned within the first post and the second post 105, 110.

During assembly of the meter post 400, wooden posts (not shown) of about 4 inches by 6 inches by 10 feet or 6 inches by 6 inches by 10 feet are positioned within the posts 105, 110.

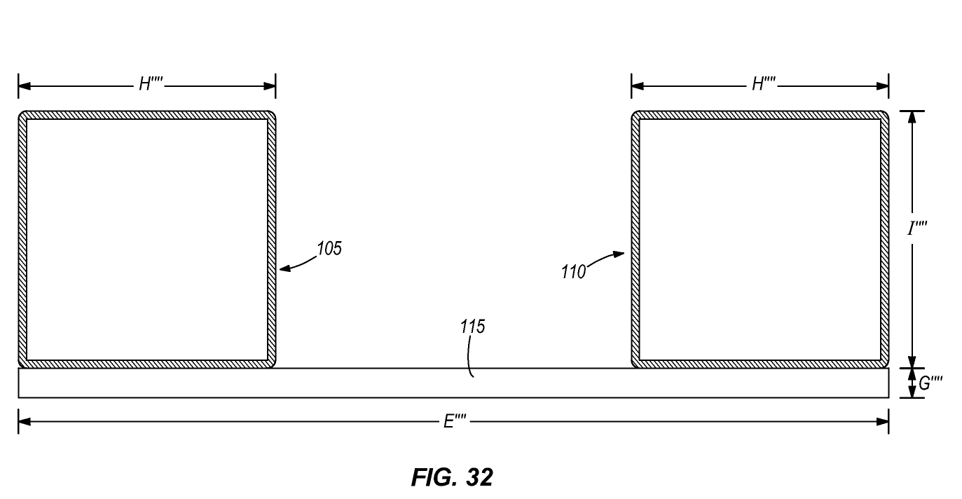

With reference to FIGS. 32-34, the posts 105, 110 define a substantially square cross-section with a width H″″ of about 6.5 inches and a depth I″″ of about 6.5 inches. The first, second, and third supports 115, 120, 125 define a length E″″ of about 22 inches, a depth of about 0.75 inches, and a height J″″ of about 5.5 inches. As indicated above, the outer shell 155 of each of the caps 150 defines a square-like periphery with a length N″″ of about 8.25 inches and a width O″″ of about 8.25 inches. A cap 150 are mounted onto each of the posts 105, 110 such that the bottom end of each cap 150 is positioned a distance M″″ of about 1 inch from the upper end of the post 105, 110. The horizontally aligned fasteners 130 are positioned a distance L″″ of about 0.75 inches from corresponding upper edge and lower edge of the first, second, and third supports 115, 120, 125. The vertically aligned fasteners 130 also are positioned a distance K″″ of about 0.75 inches from the first end and the second end of the first, second and third supports 115, 120, 125.

Various features and advantages of the invention are set forth in the following claims.

What is claimed is:

1. A meter stand comprising:
a first post comprising a PVC material, the first post including a front wall, a rear wall, a first side wall, and a second side wall defining an interior of the first post;
a second post comprising a PVC material and being oriented substantially parallel to the first post, the second post including a front wall, a rear wall, a first side wall, and a second side wall defining an interior of the second post;
a first support comprising a composite plastic material, the first support connected to and extending between the first post and the second post, the first support positioned a first predetermined distance from an upper end of the first post and the second post; and
a second support comprising a composite plastic material, the second support connected to and extending between the first post and the second post, the second support positioned a second predetermined distance from the upper end of the first post and the second post, the first predetermined distance and the second predetermined distance selected such that the first support and the second support are arranged to receive a meter box of a specific size.

2. The meter stand of claim 1, wherein the interior of the first post is configured to receive a first wooden post and the interior of the second post is configured to receive a second wooden post, and wherein at least one of the first wooden post and the second wooden post extends between the upper end and a second end of one of the first post and the second post.

3. The meter stand of claim 1, further comprising a first cap enclosing a first open end of the first post and a second cap enclosing a second open end of the second post.

4. The meter stand of claim 3, wherein the first open end is configured to receive a first wooden post and the second open end is configured to receive a second wooden post, the first post, the second post, the first cap, and the second cap substantially enclosing each of the first wooden post and the second wooden post from environment conditions.

5. The meter stand of claim 1, wherein the first support is oriented substantially parallel to the second support, and wherein the first support is oriented substantially perpendicular to the first post.

6. The meter stand of claim 1, further comprising a third support comprising a composite plastic material, the third support connected to and extending between the first post and the second post, the third support positioned a third predetermined distance from a lower end of the first post and the second post, the third predetermined distance defining an amount the first post and the second post are recessed below ground level.

7. The meter stand of claim 6, wherein the third support is substantially parallel to at least one of the first support and the second support, and wherein the third support is oriented substantially perpendicular to the first post.

8. The meter stand of claim 1, further comprising a plurality of fasteners configured to connect the first support to the first post and the second post, wherein the plurality of fasteners each include a head end and a distal end, wherein the head end extends through a front surface of the first support, and wherein the distal end extends at least partially through the front wall of the first post and into the interior.

9. The meter stand of claim 8, wherein at least one of the fasteners comprise military grade stainless steel.

10. The meter stand of claim 8, wherein the head end of the fastener is substantially flush with the front surface of the first support.

11. The meter stand of claim 1, wherein the first predetermined distance and the second predetermined distance are selected to accommodate a meter box rated and sized for 200 amps.

12. A method of manufacturing a meter stand, the method comprising:
providing a first hollow post comprising a PVC material;
providing a second hollow post comprising a PVC material;
connecting a first support between the first post and the second post, the first support comprising a composite plastic material; and
connecting a second support between the first post and the second post, the second support comprising a composite plastic material, the second support positioned a vertical distance from the first support, the vertical distance being selected such that the first support and the second support are arranged to receive a meter box of a specific size.

13. The method of claim 12, further comprising
inserting a first wooden post into the first post through a first opening therein,
inserting a second wooden post into the second post through a second opening therein,
securing a first cap over the first opening for substantially enclosing the first wooden post from environmental conditions, and
securing a second cap over the second opening for substantially enclosing the second wooden post from environmental conditions.

14. The method of claim 12, further comprising orienting the first post substantially parallel to the second post, wherein connecting the first support between the first post and the second post includes connecting the first support substantially perpendicular to the first post.

15. The method of claim 12, wherein connecting the second support between the first post and the second post includes positioning the second support substantially parallel to the first support.

16. The method of claim 12, further comprising connecting a third support between the first post and the second post, the third support comprising a composite plastic material and providing a reference for positioning a lower end of the first post and the second post below ground level.

17. The method of claim 16, wherein connecting the third support between the first post and the second post includes positioning the third support substantially parallel to at least one of the first support and the second support.

18. The method of claim 12, wherein the first support is connected to the first post and the second post with a plurality of fasteners, and wherein the fastener includes a head end and a distal end, the head end extending through a front surface of the first support and the distal end extending at least partially through a front wall of the first post.

19. The method of claim 18, wherein at least one of the plurality of fasteners includes a screw type fastener comprising military grade stainless steel.
